(19) United States
(12) Patent Application Publication
(10) Pub. No.: US 2013/0049979 A1
(43) Pub. Date: Feb. 28, 2013

(54) INDICATOR LIGHT CIRCUIT

(71) Applicant: JIE LI, Shenzhen City (CN)

(72) Inventor: JIE LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/552,718

(22) Filed: Jul. 19, 2012

(30) Foreign Application Priority Data
Aug. 31, 2011 (CN) 201110254635.0

(51) Int. Cl. G08B 5/00

(52) U.S. Cl. 340/815.4

(57) ABSTRACT

A universal indicator light circuit for indicating that a storage medium is detected by a computer includes a first electronic switch, a second electronic switch, a connecting unit, a terminal unit with three terminals and a light emitting unit. If the storage medium transmits a high level signal on detection, the second terminal of the terminal unit should be connected to the third terminal of the terminal unit through the connecting unit. If the storage medium transmits a low level signal on detection, the second terminal of the terminal unit should be connected to the first terminal of the terminal unit through the connecting unit. Thereby, the light emitting unit has a clear and unambiguous function no matter what type of storage medium is detected by the computer.

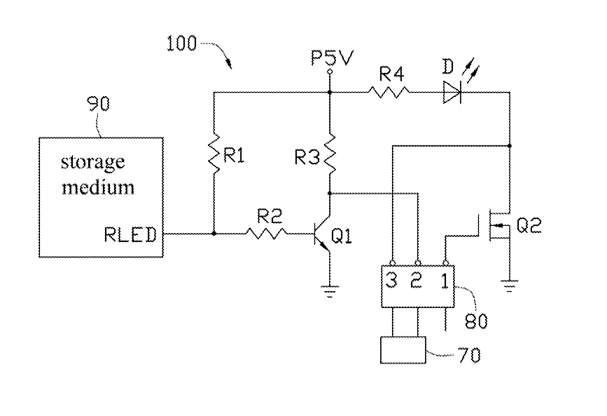

### BACKGROUND

1. Technical Field

The present disclosure relates to an indicator light circuit, and particularly to an indicator light circuit for indicating that a storage medium is detected by a computer.

2. Description of Related Art

A hard disk drive (HDD) indicator light, such as a light emitting diode (LED), may be installed in a computer for indicating whether a HDD is detected by the computer or not. The HDD indicator light will be turned on when the HDD indicator light receives a low level control signal from the HDD. The HDD indicator light is controlled by the transmitted signal of the HDD. However, the transmitted signals of the HDDs from different manufacturers may not be identical. For example, some HDDs transmit a low level signal to turn on the HDD indicator light when they are detected by the computer. In contrast, some HDDs transmit a high level signal to turn off the HDD indicator light when they are detected by the computer. Thus, users may confuse the ON state of the HDD indicator light with the OFF state of the HDD indicator light since they do not know which HDD state is being detected by the computer.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

The FIGURE is a circuit diagram of an embodiment of an indicator light circuit of the present disclosure.

### DETAILED DESCRIPTION

As shown in the FIGURE, an indicator light circuit 100 in an embodiment includes four resistive elements, first and second electronic switches, a terminal unit 80 with three terminals, a storage medium 90, a connecting unit 70 and a light emitting unit D. In this embodiment, the four resistive elements are first to fourth resistors R1-R4, the first and the second electronic switches are respectively a transistor Q1 and a field-effect transistor (FET) Q2, the three terminals are first to third terminals 1-3, the storage medium 90 is a hard disk drive (HDD), the connecting unit 70 is a jumper connector and the light emitting unit D is a light emitting diode (LED). The storage medium 90 further includes a signal pin RLED. When the storage medium 90 is detected by a computer (i.e. the storage medium 90 is detected by an input/output system when the computer is powered on), the signal pin RLED transmits a first level signal or a second level signal according to the manufacturing specifications of the storage medium 90. In this embodiment, the first level signal is a first high level signal and the second level signal is a first low level signal. In addition, the signal pin RLED transmits a pulsating signal when the storage medium 90 is being read/written to. The transistor Q1 further includes a first terminal corresponding to a base, a second terminal corresponding to a collector, and a third terminal corresponding to an emitter. The FET Q2 further includes a first terminal corresponding to a gate, a second terminal corresponding to a drain, and a third terminal corresponding to a source. The light emitting unit D further includes a first terminal corresponding to an anode and a second terminal corresponding to a cathode.

In the embodiment, the high level signal is a signal with a high level potential, and the low level signal is a signal with a low level potential, wherein a voltage between the high level potential and a ground potential is larger than each of threshold voltages of the transistor Q1 and the FET Q2, and a voltage between the low level potential and the ground potential is smaller than each of threshold voltages of the transistor Q1 and the FET Q2.

The signal pin RLED is connected to a power unit P5V through the first resistor R1 and connected to the base of the transistor Q1 through the second resistor R2. The collector of the transistor Q1 is connected to the power unit P5V through the third resistor R3 and connected to the second terminal 2 of the terminal unit 80. The emitter of the transistor Q1 is grounded. The gate of the FET Q2 is connected to the first terminal 1 of the terminal unit 80, the source of the FET Q2 is grounded, and the drain of the FET Q2 is connected to the third terminal 3 of the terminal unit 80 and the cathode of the light emitting unit D. The anode of the light emitting unit D is connected to the power unit P5V through the fourth resistor R4. The light emitting unit D gives an indication that the storage medium 90 is detected by the computer upon detection.

The connecting unit 70 connects the second terminal 2 of the terminal unit 80 to the first terminal 1 or the third terminal 3 of the terminal unit 80 according to manufacturing specifications of the storage mediums 90. If the signal pin RLED of the storage medium 90 is preset to transmit a first high level signal upon the storage medium 90 being detected by the computer, the connecting unit 70 should connect the second terminal 2 of the terminal unit 80 to the third terminal 3 of the terminal unit 80. In addition, the position of the connecting unit 70 should be changed to connect the second terminal 2 of the terminal unit 80 to the first terminal 1 of the terminal unit 80 if the signal pin RLED of the storage medium 90 is preset to transmit a first low level signal upon the storage medium 90 being detected by the computer.

An operating principle of the embodiment of the present disclosure is as follows.

When the signal pin RLED transmits the first high level signal upon the storage medium 90 being detected by the computer, the first high level signal will be received by the base of the transistor Q1. Thus, the transistor Q1 is turned on, so that the second terminal 2 of the terminal unit 80 receives the ground potential. Since the second terminal 2 of the terminal unit 80 is connected to the third terminal 3 of the terminal unit 80 through the connecting unit 70, the cathode of the light emitting unit D also receives the ground potential. Accordingly, the light emitting unit D is turned on to indicate that a storage medium 90 is detected by the computer. Furthermore, the signal pin RLED transmits a pulsating signal when the storage medium 90 is being read/written to by the computer. When the base of the transistor Q1 receives a second high level signal from the pulsating signal, this process is similar to the process of receiving a first high level signal so that the light emitting unit D is turned on. When the base of the transistor Q1 receives a second low level signal from the pulsating signal, the transistor Q1 is turned off so that the third terminal 3 receives a high level potential, i.e. an output potential of the power unit P5V, through the second terminal 2, and the light emitting unit D is turned off. Therefore, the light emitting unit D can be turned on and off alternately to flash according to the pulsating signal of the signal pin RLED.

If the signal pin RLED transmits the first low level signal when the storage medium 90 is detected by the computer, the position of the connecting unit 70 should be changed to connect the second terminal 2 of the terminal unit 80 to the first terminal 1 of the terminal unit 80. The first low level signal will be received by the base of the transistor Q1. Thus, the transistor Q1 is turned off, so that the second terminal 2 receives the high level potential of the power unit P5V. In this embodiment, the high level potential is the output potential of the power unit P5V. Since the second terminal 2 is connected to the first terminal 1 through the connecting unit 70, the gate of the FET Q2 receives the high level potential of the power unit P5V so that the FET Q2 is turned on, and the cathode of the light emitting unit D receives the ground potential. Accordingly, the light emitting unit D is turned on to indicate that a storage medium 90 is detected by the computer. Furthermore, the signal pin RLED transmits the pulsating signal when the storage medium 90 is being read/written to by the computer. When the base of the transistor Q1 receives the second low level signal from the pulsating signal, this process is similar to the process of receiving the first low level signal so that the light emitting unit D is turned off. When the base of the transistor Q1 receives the second high level signal from the pulsating signal, the transistor Q1 is turned on so that the gate of the FET Q2 receives the ground potential through the first and the second terminals 1 and 2 and the transistor Q1. Since the gate of the FET Q2 receives the ground potential, which can be regarded as a low level potential, the FET Q2 is turned off. Thus, the cathode of the light emitting unit D is connected with the third terminal 3 which is dead and the light emitting unit D is turned off. Therefore, the light emitting unit D can be turned on and off alternately to flash according to the pulsating signal of the signal pin RLED.

The transistor Q1 and the FET Q2 are used as electronic switches in this embodiment. The transistor Q1 and FET can be replaced by other kinds of transistors or electronic elements with a switching function, such as an electronic switching chip, in other embodiments.

In other embodiments, the connecting unit 70 can be other connecting devices, such as a jumper wire, and the light emitting unit D can be other light sources, such as a lamp. The first to fourth resistors R1-R4 protect the indicator light circuit. In an embodiment, the first to fourth resistors R1-R4 is not needed if the voltage of the power unit P5V is smaller than the respective breakdown voltages of the transistor Q1, the FET Q2 and the light emitting unit D.

The circuit of the above indicator light circuit 100 is simple and low cost. Users can directly connect the signal pin RLED of any storage medium 90, notwithstanding different manufacturing specifications, to the indicator light circuit 100. In addition, users can optionally connect the second terminal 2 to the first terminal 1 or to the third terminal 3, according to the signal of the storage medium 90 transmitted when the storage medium 90 is detected by the computer, by orienting the connecting unit 70 for the indication given by the light emitting unit D. Accordingly, the light emitting unit D clearly indicates whether a storage medium 90 is detected by the computer or not and a user can directly understand the indication given by the light emitting unit D without any confusion.

While the disclosure has been described by way of example and in terms of various embodiments, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An indicator light circuit comprising:
a light emitting unit configured to indicate that a storage medium is detected by a computer and comprising a first terminal connecting to a power unit and a second terminal, wherein the storage medium transmits one of a high level signal and a low level signal when the storage medium is detected by the computer;
a first electronic switch comprising a first, a second and a third terminals, wherein the first terminal of the first electronic switch is connected to the storage medium, the second terminal of the first electronic switch is connected to the power unit, and the third terminal of the first electronic switch is grounded, and wherein the first electronic switch is turned on when the high level signal is received by the first terminal of the first electronic switch, and the first electronic switch is turned off when the low level signal is received by the first terminal of the first electronic switch;
a second electronic switch comprising a first, a second and a third terminals, wherein the second terminal of the second electronic switch is connected to the second terminal of the light emitting unit, and the third terminal of the second electronic switch is grounded, and wherein the second electronic switch is turned on when a high level potential is received by the first terminal of the second electronic switch, the second electronic switch is turned off when a low level potential is received by the first terminal of the second electronic switch;
a terminal unit comprising a first, a second and a third terminals, wherein the first terminal of the terminal unit is connected to the first terminal of the second electronic switch, the second terminal of the terminal unit is connected to the second terminal of the first electronic switch, and the third terminal of the terminal unit is connected to the second terminal of the second electronic switch; and
a connecting unit configured to connect the second terminal of the terminal unit to the third terminal of the terminal unit when the storage medium transmits the high level signal and to connect the second terminal of the terminal unit to the first terminal of the terminal unit when the storage medium transmits the low level signal.

2. The indicator light circuit of claim 1, wherein the storage medium transmits a pulsating signal when the storage medium is being read/written to.

3. The indicator light circuit of claim 1, further comprising:
a first resistive element connecting the storage medium to the power unit.

4. The indicator light circuit of claim 1, further comprising:
a second resistive element connecting the storage medium to the first terminal of the first electronic switch.

5. The indicator light circuit of claim 1, further comprising:
a third resistive element connecting the power unit to the second terminal of the first electronic switch.

6. The indicator light circuit of claim 1, further comprising:
a fourth resistive element connecting the power unit to the first terminal of the light emitting unit.

7. The indicator light circuit of claim 1, wherein the first electronic switch is one of a bipolar junction transistor and a field-effect transistor, and wherein the first terminal of the first electronic switch is a base, the second terminal of the first electronic switch is a collector and the third terminal of the first electronic switch is an emitter when the first electronic switch is the bipolar junction transistor, and the first terminal of the first electronic switch is a gate, the second terminal of the first electronic switch is a drain and the third terminal of the first electronic switch is a source when the first electronic switch is the field-effect transistor.

8. The indicator light circuit of claim 1, wherein the second electronic switch is one of a bipolar junction transistor and a field-effect transistor, and wherein the first terminal of the second electronic switch is a base, the second terminal of the second electronic switch is a collector and the third terminal of the second electronic switch is an emitter when the second electronic switch is the bipolar junction transistor, and the first terminal of the second electronic switch is a gate, the second terminal of the second electronic switch is a drain and the third terminal of the second electronic switch is a source when the second electronic switch is the field-effect transistor.

9. The indicator light circuit of claim 1, wherein the connecting unit is a jumper connector.

10. The indicator light circuit of claim 1, wherein the light emitting unit is a light emitting diode (LED), and wherein the first terminal of the LED is an anode and the second terminal of the LED is a cathode.

11. The indicator light circuit of claim 1, wherein the high level potential is an output potential of the power unit and the low level potential is ground potential.

12. An indicator light circuit, comprising:
a light emitting unit configured to connect to a power unit and to generate an indication that a storage medium is detected by a computer;
a terminal unit comprising a first, a second and a third terminals;
a first electronic switch configured to connect to the second terminal and to receive a first level signal to turn on the first electronic switch and a second level signal to turn off the first electronic switch, wherein one of the first level signal and the second level signal is transmitted by the storage medium when the storage medium is detected by the computer;
a second electronic switch configured to connect to the first and the third terminals and the light emitting unit and to receive a first level potential to turn on the second electronic switch and to receive a second level potential to turn off the second electronic switch; and
a connecting unit configured to control the indication of the light emitting unit by connecting the second terminal to the third terminal when the first level signal is transmitted and by connecting the second terminal to the first terminal when the second level signal is transmitted.

13. The indicator light circuit of claim 12, wherein the first level signal is a high level signal, the second level signal is a low level signal, the first level potential is a high level potential, and the second level potential is a low level potential.

14. The indicator light circuit of claim 13, wherein the high level potential is an output potential of the power unit, and the low level potential is ground potential.
